(19) United States
(12) Patent Application Publication
(10) Pub. No.: US 2013/0243427 A1
(43) Pub. Date: Sep. 19, 2013

(54) LOSSLESS BANDWIDTH ADJUSTMENT METHOD, DEVICE AND SYSTEM

(71) Applicant: HUAWEI TECHNOLOGIES CO., LTD., Shenzhen (CN)

(72) Inventor: Yi LIN, Shenzhen (CN)

(73) Assignee: Huawei Technologies Co., Ltd., Shenzhen (CN)

(21) Appl. No.: 13/871,750

(22) Filed: Apr. 26, 2013

Related U.S. Application Data
(63) Continuation of application No. PCT/CN2011/075321, filed on Jun. 3, 2011.

(30) Foreign Application Priority Data
Nov. 8, 2010 (CN) 201010539581.8

(51) Int. Cl. H04B 10/27

(52) U.S. Cl. CPC H04B 10/27
USPC 398/45

(57) ABSTRACT

A lossless bandwidth adjustment method is provided, includes: A downstream node of an ODUflex path receives a request message from an upstream node of the ODUflex path, where the request message is used for requesting lossless adjustment of a bandwidth of the ODUflex path; the downstream node searches according to the tunnel identifier to obtain bandwidth information before adjustment of the ODUflex path, compares the bandwidth information before adjustment with the bandwidth information after adjustment, determines the number of tributary slots that need to be adjusted for a link between the downstream node and an adjacent upstream node, and selects a tributary slot that needs to be adjusted; indicates, through a label, a tributary slot after adjustment of the adjacent upstream node or the selected tributary slot that needs to be adjusted, and sends a tributary slot adjustment command to a data plane.

### CROSS-REFERENCE TO RELATED APPLICATIONS

This application is a continuation of International Patent Application No. PCT/CN2011/075321, filed on Jun. 3, 2011, which claims priority to Chinese Patent Application No. 201010539581.8, filed on Nov. 8, 2010, both of which are hereby incorporated by reference in their entireties.

### FIELD OF THE INVENTION

The present invention relates to the field of communication technologies, and in particular to a lossless bandwidth adjustment method, device and system.

### BACKGROUND OF THE INVENTION

As a core technology of a next generation transport network, an OTN (Optical Transport Network, optical transport network) can implement flexible scheduling and management of high-capacity services, and increasingly becomes a mainstream technology of a backbone transport network.

The initial OTN standard defines three types of OTN containers: ODU1 (Optical Channel Data Unit, optical channel data unit), ODU2, and ODU3. To make the OTN support Ethernet and other new services to adapt to a new application scenario, the OTN standard is expanded on an original basis, where a new signal type is put forward, for example, a bandwidth-variable ODUflex.

The ODUflex is capable of carrying a CBR (Constant Bit Rate, constant bit rate) service and a packet service of any rate. When the ODUflex is used for carrying the packet service, a GFP (Generic Framing Procedure, generic framing procedure) encapsulation manner is usually used for encapsulating the packet service in the ODUflex. Because traffic of the packet service has a feature of non-real-time variation, in different time periods, the ODUflex needs to provide different bandwidths to satisfy different traffic of the packet service, and needs to perform ODUflex tunnel bandwidth adjustment in a case that the packet service is not interrupted. That is, when the traffic of the packet service is increased, a certain number of tributary slots (Tributary Slot) need to be newly added on an ODUflex path; when the traffic of the packet service is decreased, a certain number of tributary slots need to be cut on the ODUflex path.

During bandwidth adjustment, in order not to affect transmission of a client signal, it is usually required that the ODUflex can implement lossless bandwidth adjustment, that is, it is required not to affect the client signal and then cause packet loss during an adjustment process.

An ODUflex lossless bandwidth adjustment method in the prior art is as follows:

Through a network management system, a tributary slot adjusted (added or cut) in each link is designated manually node by node. For example, in a case that an ODUflex bandwidth is increased, during a bandwidth adjustment process, an idle tributary slot is selected by a network manager from each link, and an ODUflex lossless bandwidth increase command is sent to each node through the network management system, where the command contains a serial number of the selected tributary slot, and after receiving the command, each node adds a corresponding tributary slot according to the lossless bandwidth increase command.

The prior art has at least the following disadvantages:

In the bandwidth adjustment process of the ODUflex, manual participation is needed, and the tributary slot adjusted in each link needs to be manually designated. Therefore, a configuration error easily occurs. For example, in two adjacent nodes A and B, if serial numbers of designated tributary slots are different, an error occurs.

### SUMMARY OF THE INVENTION

Embodiments of the present invention provide a lossless bandwidth adjustment method, device and system, so as to avoid problems brought by manual bandwidth adjustment, such as a low operation speed and easy occurrence of an error.

The embodiments of the present invention are implemented through the following technical solutions:

An embodiment of the present invention provides a lossless bandwidth adjustment method, including:

receiving, by a downstream node of a bandwidth-variable optical channel data unit ODUflex path, a request message from an upstream node of the ODUflex path, where the request message carries a tunnel identifier tunnel ID of the ODUflex path and bandwidth information after adjustment, the request message is used for requesting lossless adjustment of a bandwidth of the ODUflex path, and the request message is sent by a first node of the ODUflex path along the ODUflex path downstream node by node to a last node;

searching by the downstream node according to the tunnel identifier to obtain bandwidth information before adjustment of the ODUflex path, comparing the bandwidth information before adjustment with the bandwidth information after adjustment, determining the number of tributary slots that need to be adjusted for a link between the downstream node and an adjacent upstream node, and selecting a tributary slot that needs to be adjusted; and

indicating, by the downstream node and through a label, a tributary slot after adjustment of the adjacent upstream node or the selected tributary slot that needs to be adjusted, and sending a tributary slot adjustment command to a data plane, so that the data plane performs tributary slot adjustment and ODUflex bit rate adjustment according to the tributary slot adjustment command.

An embodiment of the present invention provides a lossless bandwidth adjustment method, including:

sending, by an upstream node of a bandwidth-variable optical channel data unit ODUflex path, a request message to a downstream node, where the request message carries a tunnel identifier tunnel ID of the ODUflex path, bandwidth information after adjustment and a label that contains tributary slot adjustment information determined by the upstream node, the request message is used for requesting lossless adjustment of a bandwidth of the ODUflex path, and the tributary slot adjustment information includes a tributary slot after adjustment or a tributary slot that needs to be adjusted and is selected by the upstream node;

sending, by the downstream node, a first tributary slot adjustment command to a data plane according to the tributary slot adjustment information, and in a case that the current node is not a last node of the ODUflex path, searching according to the tunnel identifier to obtain bandwidth information before adjustment of the ODUflex path, comparing the bandwidth information after adjustment with the bandwidth information before adjustment, determining the number of tributary slots that need to be adjusted for a link between the downstream node and a next node adjacent to this downstream node, determining tributary slot adjustment information according to the number of tributary slots that need to be adjusted, and continuing to send, to the next node, a request message that carries the tunnel identifier tunnel ID of the ODUflex path, the bandwidth information after adjustment and a label that contains the tributary slot adjustment information determined by the downstream node;

sending, by the downstream node, a second tributary slot adjustment command to the data plane; and

performing, by the data plane, tributary slot adjustment and ODUflex bit rate adjustment according to the first tributary slot adjustment command and the second tributary slot adjustment command, where the data plane adjusts a tributary slot of a link connection between the upstream node and the downstream node according to the first tributary slot adjustment command, and adjusts a tributary slot of a link connection between the downstream node and the adjacent next node according to the second tributary slot adjustment command.

An embodiment of the present invention provides a node device on an ODUflex path, where the node device includes:

a receiving unit, configured to receive a request message from an upstream node of the ODUflex path, where the request message carries a tunnel identifier tunnel ID of the ODUflex path and bandwidth information after adjustment, and the request message is used for requesting lossless adjustment of a bandwidth of the ODUflex path;

a tributary slot allocating unit, configured to search according to the tunnel identifier to obtain bandwidth information before adjustment of the ODUflex path, compare the bandwidth information before adjustment with the bandwidth information after adjustment, determine the number of tributary slots that need to be adjusted for a link between the node device and an adjacent upstream node, and select a tributary slot that needs to be adjusted; and

an indicating unit, configured to indicate, through a label, a tributary slot after adjustment of the adjacent upstream node or the selected tributary slot that needs to be adjusted, and send a tributary slot adjustment command to a data plane, so that the data plane performs tributary slot adjustment and ODUflex bit rate adjustment according to the tributary slot adjustment command.

An embodiment of the present invention provides a node device on an ODUflex path, where the node device includes:

a tributary slot allocating unit, configured to: in a case that a current node is not a last node of the ODUflex path, compare bandwidth information after adjustment of the ODUflex path with bandwidth information before adjustment, determine the number of tributary slots that need to be adjusted for a link between the current node and an adjacent next node, and determine tributary slot adjustment information according to the number of tributary slots that need to be adjusted, where the tributary slot adjustment information includes: a tributary slot after adjustment or a selected tributary slot that needs to be adjusted;

a sending unit, configured to send a request message to a downstream node, where the request message carries a tunnel identifier tunnel ID of the ODUflex path, the bandwidth information after adjustment and a label that contains the tributary slot adjustment information determined by the current node, and the request message is used for requesting lossless adjustment of a bandwidth of the ODUflex path; and

an indicating unit, configured to send a first tributary slot adjustment command to a data plane according to the tributary slot adjustment information, so that the data plane adjusts a tributary slot of a link connection between the current node and the adjacent next node according to the first tributary slot adjustment command.

An embodiment of the present invention provides a lossless bandwidth adjustment system, including a first node of an optical channel data unit ODUflex path and a last node of the ODUflex path, where

the first node is configured to send a request message along the ODUflex path downstream node by node to the last node, where the request message carries a tunnel identifier tunnel ID of the ODUflex path and bandwidth information after adjustment, and the request message is used for requesting lossless adjustment of a bandwidth of the ODUflex path;

the last node is configured to receive the request message, search according to the tunnel identifier to obtain bandwidth information before adjustment of the ODUflex path, compare the bandwidth information before adjustment with the bandwidth information after adjustment, determine the number of tributary slots that need to be adjusted for a link between the last node and an adjacent upstream node, select a tributary slot that needs to be adjusted, indicate, through a first label, a tributary slot after adjustment of the upstream node or the selected tributary slot that needs to be adjusted, and send a tributary slot adjustment command to a data plane, so that the data plane performs tributary slot adjustment and ODUflex bit rate adjustment according to the tributary slot adjustment command, where the adjacent upstream node is the first node or an intermediate node between the first node and the last node; and

the upstream node is configured to receive the first label, obtain the tributary slot that needs to be adjusted, and send a first tributary slot adjustment command to the data plane, so that, according to the first tributary slot adjustment command, the data plane adjusts a tributary slot of a link connection between the upstream node and the last node and performs ODUflex bit rate adjustment.

An embodiment of the present invention provides a lossless bandwidth adjustment system, including a first node of an optical channel data unit ODUflex path and a downstream node of the ODUflex path, where the downstream node is a last node of the ODUflex path or an intermediate node between the first node and the last node;

the first node is configured to send a request message to an adjacent downstream node along the ODUflex path, where the request message carries a tunnel identifier tunnel ID of the ODUflex path, bandwidth information after adjustment and a label that contains tributary slot adjustment information determined by the first node, the request message is used for requesting lossless adjustment of a bandwidth of the ODUflex path, and the tributary slot adjustment information includes a tributary slot after adjustment or a tributary slot that needs to be adjusted and is selected by the first node;

the downstream node is configured to send a first tributary slot adjustment command to a data plane according to the tributary slot adjustment information, and in a case that the current node is not the last node of the ODUflex path, search according to the tunnel identifier to obtain bandwidth information before adjustment of the ODUflex path, compare the bandwidth information after adjustment with the bandwidth information before adjustment, determine the number of tributary slots that need to be adjusted for a link between the downstream node and a next node adjacent to this downstream node, determine tributary slot adjustment information according to the number of tributary slots that need to be adjusted, and continue to send, to the next node, a request message that carries the tunnel identifier tunnel ID of the ODUflex path, the bandwidth information after adjustment and a label that contains the tributary slot adjustment information determined by the downstream node; and

the downstream node sends a second tributary slot adjustment command to the data plane; and the data plane performs tributary slot adjustment and ODUflex bit rate adjustment according to the first tributary slot adjustment command and the second tributary slot adjustment command, where the data plane adjusts a tributary slot of a link connection between the first node and the downstream node according to the first tributary slot adjustment command, and adjusts a tributary slot of a link connection between the downstream node and the adjacent next node according to the second tributary slot adjustment command.

It can be seen from the technical solutions provided by the embodiments of the present invention that, the ODUflex lossless bandwidth adjustment solution described in the embodiments implements automatic ODUflex lossless bandwidth adjustment without the need of manual participation, and therefore, problems caused by manual bandwidth adjustment, such as a heavy work load and a configuration error, are avoided. Moreover, because an adjustment command does not need to be sent manually node by node during an ODUflex lossless bandwidth adjustment process, a bandwidth adjustment speed is increased, and a bandwidth adjustment requirement of a customer is satisfied rapidly.

### BRIEF DESCRIPTION OF THE DRAWINGS

FIG. 1 is a flowchart of a lossless bandwidth adjustment method according to Embodiment 1 of the present invention;

FIG. 2 is a schematic diagram of a lossless bandwidth increase process according to Embodiment 1 of the present invention;

FIG. 3 is a schematic diagram of a lossless bandwidth decrease process according to Embodiment 2 of the present invention;

FIG. 4 is a flowchart of a lossless bandwidth adjustment method according to Embodiment 2 of the present invention;

FIG. 5 is a schematic diagram of a lossless bandwidth increase process according to Embodiment 3 of the present invention;

FIG. 6 is a schematic diagram of a lossless bandwidth decrease process according to Embodiment 4 of the present invention;

FIG. 7 is a schematic structural diagram of a node device according to Embodiment 3 of the present invention;

FIG. 8 is a schematic structural diagram of another node device according to Embodiment 3 of the present invention;

FIG. 9 is a schematic structural diagram of a node device according to Embodiment 4 of the present invention;

FIG. 10 is a schematic structural diagram of another node device according to Embodiment 4 of the present invention;

FIG. 11 is a schematic structural diagram of still another node device according to Embodiment 4 of the present invention; and

FIG. 12 is a schematic structural diagram of yet another node device according to Embodiment 4 of the present invention.

### DETAILED DESCRIPTION OF THE EMBODIMENTS

The following clearly describes the technical solutions in the embodiments of the present invention with reference to the accompanying drawings in the embodiments of the present invention. It may be understood that the described embodiments are merely a part rather than all of the embodiments of the present invention. All other embodiments obtained by persons of ordinary skill in the art based on the embodiments of the present invention without creative efforts shall fall within the protection scope of the present invention.

### Embodiment 1

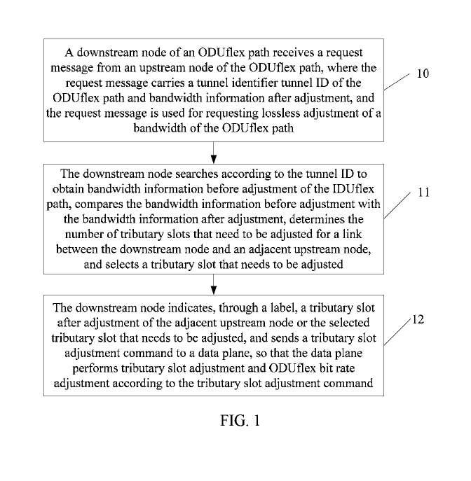

Embodiment 1 of the present invention provides a lossless bandwidth adjustment method. In this embodiment, that a downstream node of each link allocates a tributary slot is taken as an example for illustration. As shown in FIG. 1, the following steps are included:

Step 10: A downstream node of an ODUflex path receives a request message from an upstream node of the ODUflex path, where the request message carries a tunnel ID (tunnel identifier) of the ODUflex path and bandwidth information after adjustment, and the request message is used for requesting lossless adjustment of a bandwidth of the ODUflex path.

The request message is sent by a first node of the ODUflex path along the ODUflex path downstream node by node to a last node.

The first node of the ODUflex path allocates one new LSP ID (label switching path identifier) to the ODUflex path after adjustment, while the tunnel ID remains unchanged, and the new LSP ID is carried in the request message. That is, on a control plane, an LSP after bandwidth adjustment and an LSP before bandwidth adjustment are regarded as two LSPs (LSP IDs are different), but belong to a same session Session (tunnel IDs are the same).

In one embodiment, the request message may be a Path (path) message in the RSVP-TE (Resource ReserVation Protocol-Traffic Engineering, resource reservation protocol-traffic engineering) protocol. An existing SE (Shared Explicit Style, shared explicit style) flag bit may be set to 1 in a Session Attribute Object (session attribute object) in the Path message, so as to implicitly indicate that the message is used for requesting the lossless adjustment of the bandwidth of the ODUflex; and one flag bit may also be newly added to the Path message, so as to explicitly indicate that the message is used for requesting the lossless adjustment of the bandwidth of the ODUflex.

Step 11: The downstream node searches according to the tunnel ID to obtain bandwidth information before adjustment of the ODUflex path, compares the bandwidth information before adjustment with the bandwidth information after adjustment, determines the number of tributary slots that need to be adjusted for a link between the downstream node and an adjacent upstream node, and selects a tributary slot that needs to be adjusted.

Because the tunnel ID of the ODUflex path is unchanged before and after the bandwidth adjustment, each node that receives the request message may find, according to the tunnel ID and on the control plane, control information before the bandwidth adjustment, and may obtain, from the control information before the bandwidth adjustment, the bandwidth information before adjustment. By comparing the bandwidth information before adjustment with the bandwidth information after adjustment, it may be determined that whether this bandwidth adjustment is a bandwidth increase or a bandwidth decrease, so as to determine how to adjust the tributary slot. If a bandwidth after adjustment is greater than a bandwidth before adjustment, the number of tributary slots needs to be increased; if the bandwidth after adjustment is smaller than a s needs to be decreased.

The determining the number of tributary slots that need to be adjusted for the link between the downstream node and the adjacent upstream node and selecting the tributary slot that needs to be adjusted is that: The downstream node of each link determines, according to a result of comparing the bandwidth before adjustment with the bandwidth after adjustment, the number of tributary slots that need to be adjusted for this link this time, and according to the determined number of tributary slots that need to be adjusted, allocates the tributary slot that needs to be adjusted. A bandwidth that may be provided by each tributary slot is a transport resource of 1.25 Gbps. For example, for an ODU link A-B, a downstream node B determines, by comparing bandwidths before and after adjustment, that one tributary slot bandwidth before adjustment, the number of tributary slots needs to be added for this ODUflex. If this ODUflex originally occupies tributary slots numbered 2, 3 and 4 in the link A-B, the node B may randomly select an idle tributary slot in the link, for example, select a tributary slot numbered 1 and add the tributary slot numbered 1 to a link connection Link Connection of the ODUflex between A and B. The link connection refers to a transport entity used for transporting a certain service in a segment of a link. For example, one or more tributary slots in one ODU link are used for transporting one ODUflex service, and then, a transport entity formed by the one or more tributary slots is referred to as a link connection of an ODUflex in this link.

After receiving the request message, each node on the ODUflex path creates a control state on the control plane for the path after adjustment, and saves control information, where the saved control information includes the tunnel ID and the bandwidth information after adjustment, and further includes the LSP ID. In an intelligent transport network, each node may be logically divided into two parts: a control plane part and a data plane part. The control plane part is used for executing operations such as obtaining data plane information, sending, receiving and processing a control plane protocol message, and sending a command to a data plane; while the data plane part provides a transport bandwidth and executes an operation of forwarding user data. For an OTN device, its data plane further needs to process an overhead byte, so as to implement a specific function of the data plane, such as performance and failure monitoring. A control plane of a node may interconnect with another node through a control tunnel; and a data plane of the node may interconnect with another node through a data link. In an OTN network, the data link may be an ODU link.

Step 12: The downstream node indicates tributary slot adjustment information to the adjacent upstream node through a label, and sends a tributary slot adjustment command to a data plane, so that the data plane performs tributary slot adjustment and ODUflex bit rate adjustment according to the tributary slot adjustment command.

The tributary slot adjustment information includes: a tributary slot after adjustment or the selected tributary slot that needs to be adjusted.

That the downstream node indicates the tributary slot adjustment information to the adjacent upstream node through the label includes that:

The downstream node sends, to the upstream node, a response message, which carries an old label and a new label, where the new label contains a tributary slot that is occupied by the ODUflex path after adjustment in a link between the upstream node and the downstream node, and the old label contains a tributary slot that is occupied by the ODUflex path before adjustment in the link between the upstream node and the downstream node; and then the upstream node compares the new label with the old label to know the tributary slot that needs to be adjusted; or

the downstream node sends, to the upstream node, a response message, which carries a new label, where the new label contains a tributary slot that is occupied by the ODUflex path after adjustment in a link between the upstream node and the downstream node; and then the upstream node searches according to the tunnel ID in the request message to obtain an old label of the ODUflex path, where the old label contains a tributary slot that is occupied by the ODUflex path before adjustment in the link between the upstream node and the downstream node; and compares the new label with the old label to know the tributary slot that needs to be adjusted; or

the downstream node sends a response message upstream, which carries a new label, where the new label contains the selected tributary slot that needs to be adjusted, and indicates whether this tributary slot adjustment is an increase of the number of tributary slots or a decrease of the number of tributary slots.

Each node on the ODUflex path saves the new label to a control state corresponding to the ODUflex path after adjustment.

After determining tributary slot adjustment information, each node on the ODUflex path sends a tributary slot adjustment command to a data plane. That is, after determining tributary slot adjustment information, the upstream node and the downstream node of a link both send a tributary slot adjustment command to their respective data planes.

That the data plane performs the tributary slot adjustment and the ODUflex bit rate adjustment according to the tributary slot adjustment command includes that:

If the tributary slot adjustment command is a tributary slot increase command, the data plane performs the ODUflex bit rate adjustment after tributary slot adjustment of all link connections on the ODUflex path is completed; and

if the tributary slot adjustment command is a tributary slot decrease command, the data plane performs tributary slot adjustment of a link connection on the ODUflex path after completing the ODUflex bit rate adjustment.

Each node on the ODUflex path saves, to the control state corresponding to the ODUflex path after adjustment, information of a tributary slot that is used by the ODUflex path after adjustment.

The data plane notifies the control plane after completing the tributary slot adjustment and the bit rate adjustment. If the control plane receives a notification that the tributary slot adjustment and the bit rate adjustment are successfully completed, the first node of the ODUflex path sends a deletion indication message along the ODUflex path downstream node by node, for removing, on the control plane, a control state corresponding to an LSP before bandwidth adjustment.

If the control plane receives a tributary slot adjustment failure indication or an ODUflex bit rate adjustment failure indication sent by the data plane, the embodiment of the present invention provides a rollback mechanism, including:

The first node of the ODUflex path sends a rollback indication message along the ODUflex path downstream node by node; and

after receiving the rollback indication message, each node on the ODUflex path judges whether the tributary slot adjustment of the data plane is successful previously, and if successful, executes a tributary slot adjustment rollback operation, and rolls back to a state before the tributary slot adjustment, that is, deletes an added tributary slot, or adds a cut tributary slot to a link connection.

Meanwhile, if the control plane receives the tributary slot adjustment failure indication or the ODUflex bit rate adjustment failure indication sent by the data plane, each node on the ODUflex path further deletes, on the control plane, a control state corresponding to an LSP after bandwidth adjustment.

The ODUflex lossless bandwidth adjustment solution described in this embodiment implements automatic ODUflex lossless bandwidth adjustment without the need of manual participation, and therefore, problems caused by manual bandwidth adjustment, such as a heavy work load and a configuration error, are avoided. Moreover, because an adjustment command does not need to be sent manually node by node during an ODUflex lossless bandwidth adjustment process, a bandwidth adjustment speed is increased, and a bandwidth adjustment requirement of a customer is satisfied rapidly.

Meanwhile, the embodiment of the present invention provides the rollback mechanism, where in a case of adjustment failure, a state before adjustment may be rolled back to, which effectively increases reliability of ODUflex lossless bandwidth adjustment.

For further understanding of Embodiment 1 of the present invention, the following describes the solution of Embodiment 1 in detail by using specific examples.

### EXAMPLE 1

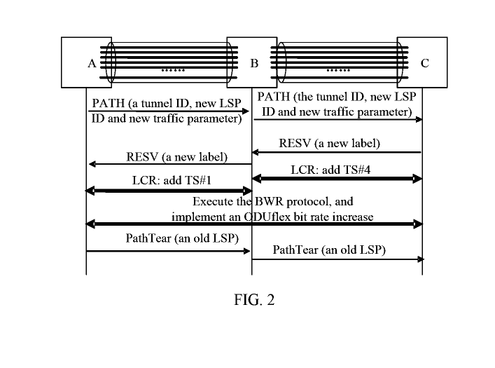

### What Is Shown in FIG. 2 Is Taken as an Example, and Is a Bandwidth Increase Procedure

It is assumed that an ODUflex path with a bandwidth of 3.75 Gbps exists among nodes A, B and C, its tunnel ID and LSP ID have been allocated, each node saves a control state of an ODUflex before bandwidth adjustment, where the control state of the ODUflex before bandwidth adjustment includes the tunnel ID, the LSP ID and a traffic parameter (used for describing a bandwidth value of the ODUflex) of the ODUflex, and a label value of the ODUflex in each link (used for describing a tributary slot occupied by the ODUflex in each link). If a first node A of the ODUflex receives a command requiring an increase of a bandwidth of the ODUflex to 5 Gbps, a lossless bandwidth adjustment process is as follows:

(1) The first node A allocates one new LSP ID to the ODUflex path, while the tunnel ID remains unchanged.

(2) The node A sends a Path message downstream node by node, until to a last node C. The Path message carries the tunnel ID, the new LSP ID and a new traffic parameter (used for describing a bandwidth of the ODUflex after adjustment, that is, 5 Gbps), and indicates that this message is an ODUflex lossless bandwidth adjustment message.

The node A creates a control state on a control plane for an LSP after adjustment, saves control information of the LSP, where the control information of the LSP includes the tunnel ID, the new LSP ID, the new traffic parameter and so on.

(3) Each node receives the Path message, creates a control state on a control plane for the LSP after adjustment, and saves the control information of the LSP.

(4) The last node C knows, according to an “ODUflex lossless adjustment indication” in the received message, that ODUflex bandwidth adjustment needs to be performed. The node C finds, according to the tunnel ID and on a control plane, a control state corresponding to an LSP before adjustment, so as to obtain, from the control state corresponding to the LSP before adjustment, a traffic parameter of the LSP before adjustment, compares the traffic parameter of the LSP before adjustment with the new traffic parameter, and calculates that the bandwidth is increased by 1.25 Gbps. Therefore, one tributary slot needs to be added. Accordingly, the node C selects one new idle tributary slot in a link B-C, for example, a tributary slot numbered 4, and sends a Resv (Reservation, reservation) message to a node B, where the message contains a new label, and the label indicates a tributary slot used by the ODUflex in the link B-C after the bandwidth adjustment, for example, labels numbered 1, 2, 3, and 4. In addition, the Resv message may contain both the new label and an old label of the ODUflex before adjustment in the link B-C.

(5) On the control plane, the last node C saves, to a control state corresponding to the LSP after adjustment, information of the tributary slot used by the ODUflex after the bandwidth adjustment; and at the same time, triggers LCR (Link Connection Resizing, link connection resizing) protocol running of a data plane of the node C, to add a newly reserved tributary slot to a link connection between B and C;

The embodiment of the present invention does not limit a sequence of the operation that the node C sends the Resv message to the node B, the operation that the node C saves, on its control plane, the information of the tributary slot used by the ODUflex after adjustment, and the operation of triggering LCR by the node C on its data plane.

(6) The node B receives the Resv message, and knows, according to a value of the label, a label of a tributary slot that is numbered 1, 2, 3, or 4 and used in the link B-C. Then the node B finds, according to the tunnel ID and on a control plane, control information corresponding to the LSP before adjustment, obtains, from the control information corresponding to the LSP before adjustment, the old label of the ODUflex before adjustment in the link B-C, and compares the old label with the new label, so as to know the tributary slot newly added in the link B-C. Alternatively, if the Resv message received by the node B further contains the old label of the ODUflex before adjustment in the link B-C, the node B directly compares the new label with the old label, so as to know the tributary slot newly added in the link B-C.

(7) On the control plane, the node B saves, to a control state corresponding to the LSP after adjustment, the information of the tributary slot used by the ODUflex after the bandwidth adjustment; and at the same time, triggers LCR protocol running of a data plane of the node B, to add the newly reserved tributary slot to the link connection between B and C.

A specific process that the nodes B and C run LCR on their data planes is as follows: The nodes B and C transport, on OTN data planes, the LCR protocol through a first overhead byte in an ODU frame, perform a handshake with each other, and in a next ODU multiframe after completion of the handshake, add a newly added tributary slot to the ODUflex link connection; and after success, change a GMP (Generic Mapping Procedure, generic mapping procedure) encapsulation manner into a special mode (special mode), where in this mode, a data plane of a node allows adjustment to be performed on a bit rate of the ODUflex.

(8) In the same way, the node B and the node A also reserve a new tributary slot in a link A-B, for example, a tributary slot numbered 1, and trigger the LCR protocol on data planes.

(9) After the LCR protocol is completed on data planes in all links through which the ODUflex passes, the first node A is automatically triggered to perform the BWR (BandWidth Resizing, bandwidth resizing) protocol, to complete an increase of the rate of the ODUflex.

The BWR protocol is transported on an OTN data plane through a second overhead byte in the ODU frame. A process that the first node A is automatically triggered to perform the BWR protocol is as follows:

(a) After receiving the ODUflex lossless bandwidth adjustment message, before starting the LCR protocol, each node blocks the second overhead byte used by the BWR protocol, that is, ignores information in the overhead byte for transporting BWR, so that the information in the BWR overhead byte cannot be transferred to a next node.

(b) Between adjacent nodes, for example, between A and B or between B and C, after the LCR protocol is successfully run, the blocking of the BWR overhead byte is stopped, that is, the BWR overhead byte is transferred transparently.

(c) After all nodes complete LCR, a BWR overhead byte of the first node A may be transferred transparently to the last node C, and the last node C also responds with a BWR overhead byte after reception. After receiving a BWR response message, the first node A adjusts the ODUflex rate in a next ODU multiframe, and after the adjustment succeeds, indicates adjustment success through a BWR overhead. After receiving a BWR success indication, each node of the ODUflex path closes the GMP special mode.

(10) After successfully completing the BWR protocol on a data plane, the first node A notifies its control plane.

(11) The first node A sends a PathTear message to a downstream node hop by hop, for removing, on the control plane, the LSP before bandwidth adjustment, that is, deletes, on the control plane, the control state corresponding to the LSP before adjustment.

It should be noted that, the ODUflex lossless bandwidth adjustment process cannot be nested. That is, for a same ODUflex service, after initiating first ODUflex lossless bandwidth adjustment, and before completing the adjustment, the first node cannot initiate a next operation of ODUflex lossless bandwidth adjustment. Correspondingly, in the ODUflex lossless adjustment process, on the control plane of each node, at most two control states can be saved for the ODUflex path, one for saving control information of the LSP before adjustment, and the other for saving control information of the LSP after adjustment.

On the data plane, if there is a failure in LCR running, which causes that the node A cannot start the BWR protocol before time expires (that is, in a period of time after starting the ODUflex bandwidth adjustment, the node A does not receive the BWR response message), or if the node A fails after running the BWR protocol, the node A sends the PathTear message to the downstream node node by node, indicates deletion of the control state corresponding to the LSP after adjustment, and performs a rollback operation on the data plane. A node that receives the PathTear message first judges whether LCR between the current node and an upstream node is successfully run previously; if successful, needs to run the LCR protocol again, and deletes a previously added tributary slot from a link connection; if unsuccessful, does not need to perform a rollback operation on a control plane. In addition, each node further deletes the control state corresponding to the LSP after adjustment and is created on the control plane previously.

### EXAMPLE 2

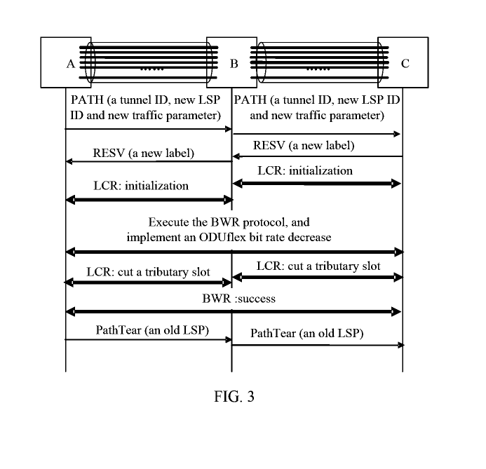

### What Is Shown in FIG. 3 Is Taken as an Example, and Is a Bandwidth Decrease Procedure

It is assumed that an ODUflex path with a bandwidth of 5 Gbps exists among nodes A, B and C,, its tunnel ID and LSP ID have been allocated, each node saves a control state of an ODUflex before bandwidth adjustment, where the control state of the ODUflex before bandwidth adjustment includes the tunnel ID, the LSP ID and a traffic parameter (used for describing a bandwidth value of the ODUflex) of the ODUflex, and a label value of the ODUflex in each link (used for describing a tributary slot occupied by the ODUflex in each link). If a first node A of the ODUflex receives a command requiring a decrease of a bandwidth of the ODUflex to 3.75 Gbps, a lossless bandwidth adjustment process is relatively similar to the bandwidth increase process in Example 1, where main differences are as follows:

(1) On a control plane, a bandwidth value in a new traffic parameter in a Path message is smaller than an original one, and each node compares new and old bandwidths to know that the bandwidth needs to be decreased. In a Resv message, a tributary slot to be cut is obtained by comparing a new label with an old label, or a new label directly carries a tributary slot to be cut.

(2) On a data plane, a bandwidth decrease process is the opposite of a bandwidth increase process, and requires that a rate of the ODUflex is decreased and then a tributary slot is cut from a link connection. A specific process is:

Each node on the ODUflex path receives the Resv message, and after determining the tributary slot that needs to be cut, on the data plane, first run LCR to perform link connection resizing initialization, which specifically is: Each node on the ODUflex path blocks a second overhead byte used by the BWR protocol; then, an LCR protocol handshake is performed between each pair of adjacent nodes, and after completing the handshake, two adjacent nodes both change a GMP encapsulation manner into a special mode, and then stop blocking BWR, that is, transparently transfer a BWR overhead byte, while temporarily suspending the LCR protocol.

After LCR of all links through which the ODUflex passes is successfully initialized, BWR is run between the first node A and a last node C, to decrease the rate of the ODUflex, which specifically is: After the LCR of all links through which the ODUflex passes is successfully initialized, a BWR overhead byte of the first node A may be transparently transferred to the last node C, and the last node C also responds with a BWR overhead byte after reception; after receiving a BWR response message, the first node A adjusts the ODUflex rate in a next ODU multiframe, and after the adjustment succeeds, indicates adjustment success through a BWR overhead to each node on the ODUflex path.

Finally, the LCR protocol is run in each node through which the ODUflex passes, and a previously designated tributary slot is deleted from a corresponding link connection. Specifically, after receiving a BWR success indication, each node of the ODUflex path closes a GMP special mode, and at the same time, each pair of adjacent nodes deletes the designated tributary slot from the link connection of the ODUflex in the next ODU multiframe after the LCR protocol handshake.

If an abnormality occurs when the data plane performs LCR or BWR, and causes that the bandwidth adjustment is unsuccessful, a rollback operation needs to be performed, and a state before the bandwidth adjustment is restored, which is specifically as follows:

(1) After receiving a Resv response message, the first node A waits for a result of bandwidth adjustment of a data plane. If the bandwidth adjustment of the data plane of the node A is unsuccessful, an adjustment error is reported to a control plane of the node A.

(2) The node A sends a PathTear message along an LSP direction node by node to a downstream node, to request that an LSP after bandwidth adjustment is deleted on the control plane, that is, that a control state of the LSP after bandwidth adjustment is deleted on the control plane.

(3) Each node that receives the message judges whether a previous tributary slot decrease operation is successful; if successful, needs to run the LCR protocol again, and adds a cut tributary slot to a link connection again; if unsuccessful, does not need this rollback operation. At the same time, each node deletes a control state that is of the LSP after bandwidth adjustment and is created on the control plane previously.

### Embodiment 2

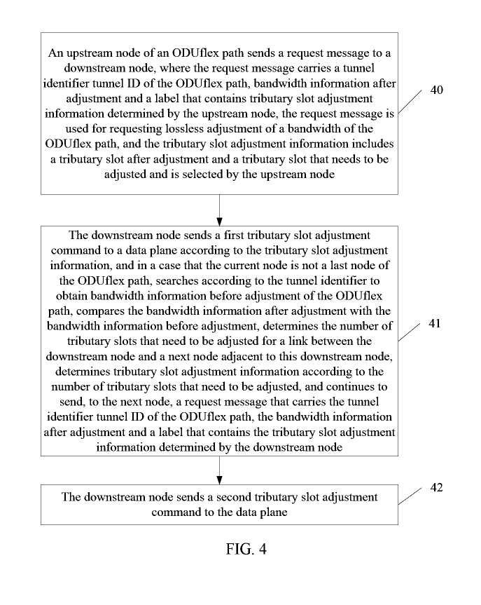

A difference between this embodiment and Embodiment 1 is that, that an upstream node of each link on an ODUflex path allocates a tributary slot is taken as an example for illustration in this embodiment. As show in FIG. 4, the following steps are included:

Step 40: An upstream node of an ODUflex path sends a request message to a downstream node, where the request message carries a tunnel identifier tunnel ID of the ODUflex path, bandwidth information after adjustment and a label that contains tributary slot adjustment information determined by the upstream node, the request message is used for requesting lossless adjustment of a bandwidth of the ODUflex path, and the tributary slot adjustment information includes a tributary slot after adjustment or a tributary slot that needs to be adjusted and is selected by the upstream node.

The request message is first sent by a first node of the ODUflex path along the ODUflex path to a node adjacent to the first node.

After determining the tributary slot adjustment information, the upstream node saves, to a control state corresponding to an LSP after adjustment, information of a tributary slot used by an ODUflex after bandwidth adjustment; and at the same time, triggers LCR protocol running of a data plane of the upstream node to perform tributary slot adjustment and ODUflex bit rate adjustment.

The first node of the ODUflex path allocates one new LSP ID (label switching path identifier) to the ODUflex path after adjustment, while the tunnel ID remains unchanged, and the new LSP ID is carried in the request message. That is, on a control plane, an LSP after bandwidth adjustment and an LSP before bandwidth adjustment are regarded as two LSPs (LSP IDs are different), but belong to a same session Session (tunnel IDs are the same).

In one embodiment, the request message may be a Path message in the RSVP-TE protocol. An existing SE (Shared Explicit Style, shared explicit style) flag bit may be set to 1 in a Session Attribute Object object in the Path message, so as to implicitly indicate that the message is used for requesting the lossless adjustment of the bandwidth of the ODUflex; and one flag bit may also be newly added in the Path message, so as to explicitly indicate that the message is used for requesting the lossless adjustment of the bandwidth of the ODUflex.

A method for each node of the ODUflex path to determine the tributary slot adjustment information is the same as the method that is for determining tributary slot adjustment information when an downstream node allocates a tributary slot and is described in Embodiment 1, and includes: searching according to the tunnel ID to obtain bandwidth information before adjustment of the ODUflex path, comparing the bandwidth information after adjustment with the bandwidth information before adjustment, determining the number of tributary slots that need to be adjusted between the node and an adjacent downstream node, and selecting, according to the number of tributary slots, a tributary slot that needs to be adjusted. After receiving a bandwidth adjustment command, the first node of the ODUflex path directly compares the bandwidth information after adjustment of the ODUflex path with the bandwidth information before adjustment of the ODUflex path, to determine the number of tributary slots that need to be adjusted between the first node and an adjacent downstream node, and select, according to the number of tributary slots, a tributary slot that needs to be adjusted.

Step 41: The downstream node sends a first tributary slot adjustment command to a data plane according to the tributary slot adjustment information, and in a case that the current node is not a last node of the ODUflex path, searches according to the tunnel identifier to obtain bandwidth information before adjustment of the ODUflex path, compares the bandwidth information after adjustment with the bandwidth information before adjustment, determines the number of tributary slots that need to be adjusted for a link between the downstream node and a next node adjacent to this downstream node, determines tributary slot adjustment information according to the number of tributary slots that need to be adjusted, and continues to send, to the next node, a request message that carries the tunnel identifier tunnel ID of the ODUflex path, the bandwidth information after adjustment and a label that contains the tributary slot adjustment information determined by the downstream node.

By using the method in step 41, each node on the ODUflex path, as an upstream node of a link, determines tributary slot adjustment information between the node and an adjacent downstream node, and then sends a request message to the downstream node, until to the last node of the ODUflex path.

After receiving the request message, each node on the ODUflex path creates a control state on the control plane for the path after adjustment, and saves control information, where the saved control information includes the tunnel ID and the bandwidth information after adjustment, and further includes the LSP ID.

Each node on the ODUflex path saves, to a control state corresponding to the ODUflex path after adjustment (corresponding to the new LSP ID), information of a tributary slot occupied by the ODUflex path after adjustment.

A method for the upstream node to indicate the tributary slot adjustment information to the downstream node through the label is the same as the method which is for a downstream node to indicate tributary slot adjustment information to an upstream node through a label and is in Embodiment 1, and is not repeatedly described herein.

Step 42: The downstream node sends a second tributary slot adjustment command to the data plane.

In step 41 and step 42, the data plane performs the tributary slot adjustment and ODUflex bit rate adjustment according to the first tributary slot adjustment command and the second tributary slot adjustment command respectively, where the data plane adjusts a tributary slot of a link connection between the upstream node and the downstream node according to the first tributary slot adjustment command, and adjusts a tributary slot of a link connection between the downstream node and the adjacent next node according to the second tributary slot adjustment command.

That the data plane performs the tributary slot adjustment and ODUflex bit rate adjustment according to the first tributary slot adjustment command and the second tributary slot adjustment command includes:

If the first tributary slot adjustment command and the second tributary slot adjustment command are tributary slot increase commands, the data plane performs the ODUflex bit rate adjustment after tributary slot adjustment of all link connections on the ODUflex path is completed; and

If the first tributary slot adjustment command and the second tributary slot adjustment command are tributary slot decrease commands, the data plane performs tributary slot adjustment of a link connection on the ODUflex path after completing the ODUflex bit rate adjustment.

The data plane notifies the control plane after completing the tributary slot adjustment and the ODUflex bit rate adjustment. If the control plane receives a notification that the tributary slot adjustment and the bit rate adjustment are successfully completed, the first node of the ODUflex path sends a deletion indication message along the ODUflex path downstream node by node, for removing, on the control plane, a control state of an LSP before bandwidth adjustment.

If the control plane receives a tributary slot adjustment failure indication or an ODUflex bit rate adjustment failure indication sent by the data plane, the embodiment of the present invention provides a rollback mechanism, including:

The first node of the ODUflex path sends a rollback indication message along the ODUflex path downstream node by node; and

after receiving the rollback indication message, each node on the ODUflex path judges whether the tributary slot adjustment of the data plane is successful previously, and if successful, executes a tributary slot adjustment rollback operation, and rolls back to a state before the tributary slot adjustment, that is, deletes an added tributary slot, or adds a cut tributary slot to a link connection.

Meanwhile, after the control plane receives the tributary slot adjustment failure indication or the ODUflex bit rate adjustment failure indication sent by the data plane, each node on the ODUflex path further deletes, on the control plane, a control state corresponding to an LSP after bandwidth adjustment.

The ODUflex lossless bandwidth adjustment solution described in this embodiment implements automatic ODUflex lossless bandwidth adjustment without the need of manual participation, and therefore, problems caused by manual bandwidth adjustment, such as a heavy work load and a configuration error, are avoided. Moreover, because an adjustment command does not need to be sent manually node by node during an ODUflex lossless bandwidth adjustment process, a bandwidth adjustment speed is increased, and a bandwidth adjustment requirement of a customer is satisfied rapidly.

Meanwhile, the embodiment of the present invention provides the rollback mechanism, where a state before adjustment may be rolled back to in a case of adjustment failure, which effectively increases reliability of ODUflex lossless bandwidth adjustment.

For further understanding of Embodiment 2 of the present invention, the following describes the solution of Embodiment 2 in detail by using specific examples.

### EXAMPLE 3

### What Is Shown in FIG. 5 Is Taken as an Example, and Is a Bandwidth Increase Procedure

It is assumed that an ODUflex path with a bandwidth of 3.75 Gbps exists among nodes A, B and C,, its tunnel ID and LSP ID have been allocated, each node saves a control state of an ODUflex before bandwidth adjustment, where the control state of the ODUflex before bandwidth adjustment includes the tunnel ID, the LSP ID and a traffic parameter (used for describing a bandwidth value of the ODUflex) of the ODUflex, and a label value of the ODUflex in each link (used for describing a tributary slot occupied by the ODUflex in each link). If a first node A of the ODUflex receives a command requiring an increase of a bandwidth of the ODUflex to 5 Gbps, a lossless bandwidth adjustment process is as follows:

(1) The node A allocates one new LSP ID to the ODUflex path, while the tunnel ID remains unchanged.

(2) According to the received ODUflex bandwidth adjustment command, the node A compares ODUflex bandwidth values before and after bandwidth adjustment, calculates that the bandwidth is increased by 1.25 Gbps. Therefore, one tributary slot needs to be added. Accordingly, the node A selects one new idle tributary slot in a link A-B, for example, a tributary slot numbered 1, and sends a Path message to a node B, where the message carries the tunnel ID, the new LSP ID and a new traffic parameter (used for describing a bandwidth of the ODUflex after adjustment, that is, 5 Gbps), and indicates that the message is an ODUflex lossless bandwidth adjustment message. At the same time, the message further contains a new label, and the label indicates a tributary slot used by the ODUflex in the link A-B after the bandwidth adjustment, for example, labels numbered 1, 2, 3, and 4. In addition, the Path message may also contain both the new label and an old label of the ODUflex before adjustment in the link A-B.

The node A creates a control state on a control plane for an LSP after adjustment, saves control information of the LSP, where the control information of the LSP includes the tunnel ID, the new LSP ID, the new traffic parameter, the new label and so on.

At the same time, the node A triggers LCR (Link Connection Resizing, link connection resizing) protocol running of its data plane, and adds a newly reserved tributary slot to a link connection between A and B.

(3) The node B receives the Path message, and knows, according to an “ODUflex lossless adjustment indication” in the received message, that ODUflex bandwidth adjustment needs to be performed; and at the same time, creates a control state on a control plane for the LSP after adjustment, and saves control information of the LSP.

The node B knows, according to a value of the label, a label of a tributary slot that is numbered 1, 2, 3, or 4 and used in the link A-B. Then the node B finds, according to the tunnel ID and on the control plane, control information corresponding to an LSP before adjustment, obtains, from the control information corresponding to the LSP before adjustment, an old label of the LSP before adjustment in the link A-B, and compares the old label with the new label, so as to know the tributary slot newly added in the link A-B. Alternatively, if the Path message received by the node B further contains the old label of the ODUflex before adjustment in the link A-B, the node B directly compares the new label with the old label, so as to know the tributary slot newly added in the link A-B.

(4) On the control plane, the node B saves, to the control information corresponding to the LSP after adjustment, information of the tributary slot used by the ODUflex after the bandwidth adjustment; and at the same time, triggers LCR protocol running of a data plane of the node B, and adds the newly reserved tributary slot to the link connection between A and B.

A specific process that the nodes A and B run LCR on their data planes is as follows: The nodes A and B transport, on OTN data planes, the LCR protocol through a first overhead byte in an ODU frame, perform a handshake with each other, and in a next ODU multiframe after completion of the handshake, add a newly added tributary slot to the ODUflex link connection; and after success, change a GMP encapsulation manner into a special mode (special mode).

(5) As an upstream node of a link B-C, the node B finds, according to the tunnel ID in the received Path message and on the control plane, a control state corresponding to the LSP before adjustment, and obtains, from the control state corresponding to the LSP before adjustment, the traffic parameter of the LSP before adjustment and an old label of the ODUflex before adjustment on the link B-C; the node B compares the traffic parameter of the LSP before adjustment with the new traffic parameter in the Path message, and calculates a bandwidth increase of 1.25 Gbps. Therefore, one tributary slot needs to be added. Accordingly, the node B selects one new idle tributary slot in the link B-C, for example, a tributary slot numbered 4, and sends a Path message to a node C, where the message carries the tunnel ID, the new LSP ID and the new traffic parameter, and indicates that this message is also an ODUflex lossless bandwidth adjustment message. At the same time, the message further contains a new label, and the label indicates a tributary slot used by the ODUflex in the link B-C after the bandwidth adjustment, for example, labels numbered 1, 2, 3, and 4. In addition, the Path message may also contain both the new label and an old label of the ODUflex before adjustment in the link B-C.

At the same time, the node B triggers LCR (Link Connection Resizing, link connection resizing) protocol running of its data plane, and adds a newly reserved tributary slot to a link connection between B and C.

(6) A node C receives the Path message, and knows, according to an “ODUflex lossless adjustment indication” in the received message, that ODUflex bandwidth adjustment needs to be performed; and at the same time, creates a control state on a control plane for the LSP after adjustment, and saves control information of the LSP.

The node C knows, according to a value of the label, a label of a tributary slot that is numbered 1, 2, 3, or 4 and used in the link B-C. Then the node C finds, according to the tunnel ID and on the control plane, control information corresponding to an LSP before adjustment, obtains, from the control information corresponding to the LSP before adjustment, an old label of the LSP before adjustment in the link B-C, and compares the old label with the new label, so as to know the tributary slot newly added in the link B-C. Alternatively, if the Path message received by the node C further contains the old label of the ODUflex before adjustment in the link B-C, the node C directly compares the new label with the old label, so as to know the tributary slot newly added in the link B-C.

(7) On the control plane, the node C saves, to the control information corresponding to the LSP after adjustment, information of the tributary slot used by the ODUflex after the bandwidth adjustment; and at the same time, triggers LCR protocol running of a data plane of the node C, and adds the newly reserved tributary slot to the link connection between B and C.

A specific process that nodes B and C run LCR on their data planes is the same as the specific process that nodes A and B run LCR on their data planes.

(8) Beginning from the last node C, a Resv message is sent hop by hop to the first node A, where the message indicates that a bandwidth is successfully increased for the ODUflex on the control plane.

In this embodiment, the node C may send a Resv message to the node B after successfully determining the tributary slot to be added in the link B-C, and it is not required that the Resv message is sent to the node B after its data plane is triggered to run LCR or after the data plane completes LCR. In the same way, after receiving the Resv message sent by the node C, the node B may send a Resv message to the node A after successfully determining the tributary slot to be added in the link B-C.

(9) After the LCR protocol is completed on data planes in all links through which the ODUflex passes, the first node A is automatically triggered to perform the BWR (BandWidth Resizing, bandwidth resizing) protocol, to complete an increase of the rate of the ODUflex.

The BWR protocol is transported on an OTN data plane through a second overhead byte in the ODU frame. A process that the first node A is automatically triggered to perform the BWR protocol is as follows:

(a) After receiving the bandwidth adjustment command, before starting the LCR protocol, each node blocks the second overhead byte used by the BWR protocol, that is, ignores information in the overhead byte for transporting BWR, so that the information in the BWR overhead byte cannot be transferred to a next node.

(b) Between adjacent nodes (for example, between A and B or between B and C), after the LCR protocol is successfully run, the blocking of the BWR overhead byte is stopped, that is, the BWR overhead byte is transferred transparently.

(c) After all nodes complete LCR, a BWR overhead byte of the first node A may be transferred transparently to the last node C, and the last node C also responds with a BWR overhead byte after reception. After receiving a BWR response message, the first node A adjusts the ODUflex rate in a next ODU multiframe, and after the adjustment succeeds, indicates adjustment success through a BWR overhead. After receiving a BWR success indication, each node of the ODUflex path closes the GMP special mode.

(10) After successfully completing the BWR protocol on the data plane, the first node A notifies its control plane.

(11) The first node A sends a PathTear message to a downstream node hop by hop, for removing, on the control plane, the LSP before bandwidth adjustment, that is, deletes, on the control plane, the control state corresponding to the LSP before adjustment.

It should be noted that, the ODUflex lossless bandwidth adjustment process cannot be nested. That is, for a same ODUflex service, after initiating first ODUflex lossless adjustment, and before completing the adjustment, the first node cannot initiate a next operation of ODUflex lossless bandwidth adjustment. Correspondingly, in the ODUflex lossless adjustment process, on the control plane of each node, at most two control states can be saved for the ODUflex path, one for saving control information of the LSP before adjustment, and the other for saving control information of the LSP after adjustment.

On the data plane, if there is a failure in LCR running, which causes that the node A cannot start the BWR protocol before time expires (that is, in a period of time after starting the ODUflex bandwidth adjustment, the node A does not receive the BWR response message), or if the node A fails after running the BWR protocol, the node A sends the PathTear message to the downstream node node by node, indicates deletion of the control state corresponding to the LSP after adjustment, and performs a rollback operation on the data plane. A node that receives the PathTear message first judges whether LCR between the current node and an upstream node is successfully run previously; if successful, needs to run the LCR protocol again, and deletes a previously added tributary slot from a link connection; if unsuccessful, does not need to perform a rollback operation on a control plane. In addition, each node on the ODUflex path further deletes the control state corresponding to the LSP after adjustment and is created on the control plane previously.

### EXAMPLE 4

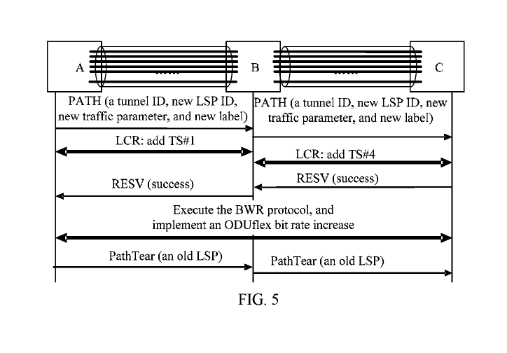

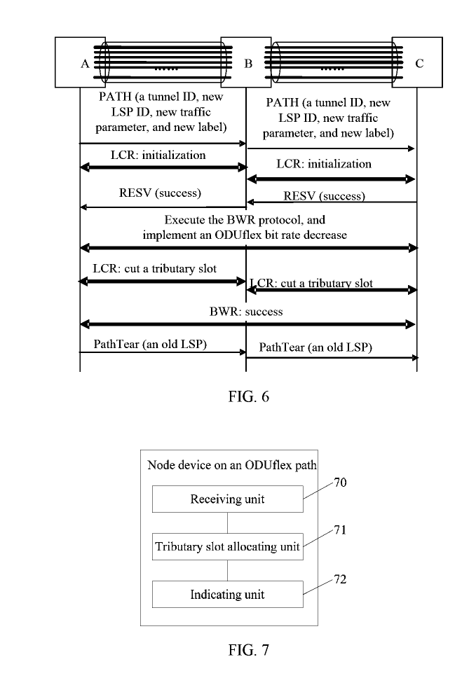

### What Is Shown in FIG. 6 Is Taken as an Example, and Is a Bandwidth Decrease Procedure

It is assumed that an ODUflex path with a bandwidth of 5 Gbps exists among nodes A, B and C,, its tunnel ID and LSP ID have been allocated, each node saves a control state of an ODUflex before bandwidth adjustment, where the control state of the ODUflex before bandwidth adjustment includes the tunnel ID, the LSP ID and a traffic parameter (used for describing a bandwidth value of the ODUflex) of the ODUflex, and a label value of the ODUflex in each link (used for describing a tributary slot occupied by the ODUflex in each link). If a first node A of the ODUflex receives a command requiring a decrease of a bandwidth of the ODUflex to 3.75 Gbps, a lossless bandwidth adjustment process is relatively similar to the bandwidth increase process in Example 3, where main differences are as follows:

(1) On a control plane, a bandwidth value in a new traffic parameter in a Path message is smaller than an original one, and each node compares new and old bandwidths to know that the bandwidth needs to be decreased. Meanwhile, in a Path message, a tributary slot to be cut is obtained by comparing a new label with an old label, or a new label directly carries a tributary slot to be cut.

(2) On a data plane, a bandwidth decrease process is the opposite of a bandwidth increase process, and requires that a rate of the ODUflex is decreased and then a tributary slot is cut from a link connection. A specific process is:

After a first node on the ODUflex path receives an ODUflex lossless bandwidth adjustment command, or after each downstream node receives a Path message, the tributary slot that needs to be cut is determined, and on the data plane, LCR is first run to perform link connection resizing initialization, which specifically is: Each node on the ODUflex path blocks a second overhead byte used by the BWR protocol; then, an LCR protocol handshake is performed between each pair of adjacent nodes, and after completing the handshake, two adjacent nodes both change a GMP encapsulation manner into a special mode, and then stop blocking BWR, that is, transparently transfer a BWR overhead byte, while temporarily suspending the LCR protocol.

After LCR of all links through which the ODUflex passes is successfully initialized, BWR is run between the first node A and a last node C, to decrease the rate of the ODUflex, which specifically is: A BWR overhead byte of the first node A may be transparently transferred to the last node C, and the last node C also responds with a BWR overhead byte after reception; after receiving a BWR response message, the first node A adjusts the ODUflex rate in a next ODU multiframe, and after the adjustment succeeds, indicates adjustment success through a BWR overhead to each node on the ODUflex path.

Finally, the LCR protocol is run in each node through which the ODUflex passes, and a previously designated tributary slot is deleted from a corresponding link connection. Specifically, after receiving a BWR success indication, each node of the ODUflex path closes a GMP special mode, and at the same time, each pair of adjacent nodes deletes the designated tributary slot from the link connection of the ODUflex in the next ODU multiframe after the LCR protocol handshake.

If abnormality occurs when the data plane performs LCR or BWR, and causes that the bandwidth adjustment is unsuccessful, a rollback operation needs to be performed, and a state before the bandwidth adjustment is restored, which is specifically as follows:

(a) After receiving a Resv response message, the first node A waits for a result of bandwidth adjustment of a data plane. If the bandwidth adjustment of the data plane of the node A is unsuccessful, an adjustment error is reported to a control plane of the node A.

(b) The node A sends a PathTear message along an LSP direction node by node to a downstream node, to request that an LSP after bandwidth adjustment is deleted on the control plane, that is, a control state of the LSP after bandwidth adjustment is deleted on the control plane.

(c) Each node that receives the message judges whether a previous tributary slot decrease operation is successful; if successful, needs to run the LCR protocol again, and adds a cut tributary slot to a link connection again; if unsuccessful, does not need this rollback operation. At the same time, each node deletes a control state that is of the LSP after bandwidth adjustment and is created on the control plane previously.

### Embodiment 3

Embodiment 3 of the present invention provides a node device on an ODUflex path. The node device is a downstream node of each link on the ODUflex path. As shown in FIG. 7, the node device includes:

a receiving unit 70, configured to receive a request message from an upstream node on the ODUflex path, where the request message carries a tunnel ID of the ODUflex path and bandwidth information after adjustment, the request message is used for requesting lossless adjustment of a bandwidth of the ODUflex path, and the request message received by the receiving unit 70 contains a new LSP ID allocated by a first node of the ODUflex path for the ODUflex path after adjustment;

a tributary slot allocating unit 71, configured to search according to the tunnel ID to obtain bandwidth information before adjustment of the ODUflex path, compare the bandwidth information before adjustment with the bandwidth information after adjustment, determine the number of tributary slots that need to be adjusted for a link between the node device and an adjacent upstream node, and select a tributary slot that needs to be adjusted; and

an indicating unit 72, configured to indicate, through a label, a tributary slot after adjustment of the adjacent upstream node or the selected tributary slot that needs to be adjusted, and send a tributary slot adjustment command to a data plane, so that the data plane performs tributary slot adjustment and ODUflex bit rate adjustment according to the tributary slot adjustment command.

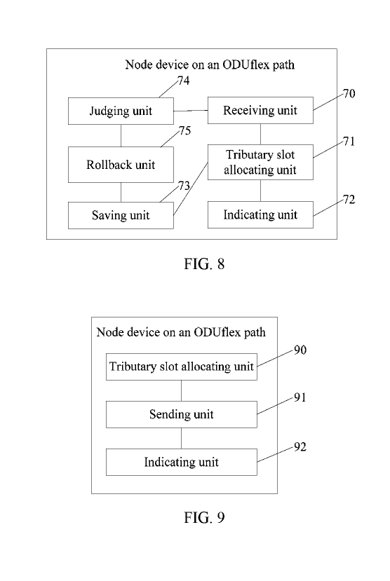

As shown in FIG. 8, the node device further includes:

a saving unit 73, configured to create a control state for the path after adjustment, save control information, where the saved control information includes the tunnel ID, the bandwidth information after adjustment, and the new LSP ID, and save, to the corresponding control state, information of a tributary slot occupied by the ODUflex path after adjustment.

The receiving unit 70 is further configured to receive a rollback indication message that is sent by the first node of the ODUflex path along the ODUflex path downstream node by node. The node device further includes:

a judging unit 74, configured to: after the receiving unit receives the rollback indication message, judge whether the tributary slot adjustment of the data plane is successful; and

a rollback unit 75, configured to: in a case that the judging unit 74 judges that the tributary slot adjustment is successful, execute a tributary slot adjustment rollback operation, and roll back to a state before the tributary slot adjustment.

The node device described in this embodiment corresponds to a downstream node of each link on an ODUflex path in Embodiment 1. To highlight an inventive point of the node device in this embodiment, some functions of the node device are ignored in this embodiment, for example, functions such as triggering, after the tributary slot adjustment information is determined, a tributary slot adjustment operation and bit rate adjustment performed by the data plane.

The node device described in the embodiment of the present invention can implement automatic ODUflex lossless bandwidth adjustment, and therefore, problems caused by manual bandwidth adjustment, such as a heavy work load and a configuration error, are avoided. Moreover, because an adjustment command does not need to be sent manually node by node during an ODUflex lossless bandwidth adjustment process, a bandwidth adjustment speed is increased, and a bandwidth adjustment requirement of a customer is satisfied rapidly.

Meanwhile, the node device in this embodiment provides a rollback mechanism, where a state before adjustment may be rolled back to in a case of adjustment failure, which effectively increases reliability of ODUflex lossless bandwidth adjustment.

### Embodiment 4

This embodiment provides a node device on an ODUflex path. The node device is an upstream node of each link on the ODUflex path. As shown in FIG. 9, the node device includes:

a tributary slot allocating unit 90, configured to: in a case that the current node is not a last node of the ODUflex path, compare bandwidth information after adjustment of the ODUflex path with bandwidth information before adjustment, determine the number of tributary slots that need to be adjusted for a link between the current node and an adjacent next node, and determine tributary slot adjustment information according to the number of tributary slots that need to be adjusted, where the tributary slot adjustment information includes: a tributary slot after adjustment or a selected tributary slot that needs to be adjusted;

a sending unit 91, configured to send a request message to a downstream node, where the request message carries a tunnel identifier tunnel ID of the ODUflex path, the bandwidth information after adjustment and a label that contains the tributary slot adjustment information determined by the current node, and the request message is used for requesting lossless adjustment of a bandwidth of the ODUflex path; and

an indicating unit 92, configured to send a first tributary slot adjustment command to a data plane according to the tributary slot adjustment information, so that the data plane adjusts a tributary slot of a link connection between the current node and the adjacent next node according to the first tributary slot adjustment command.

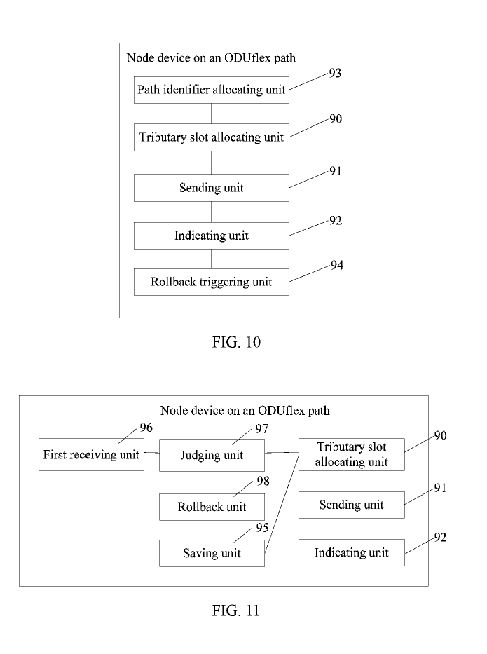

As shown in FIG. 10, when the node device is a first node of the ODUflex path, the node device further includes:

a path identifier allocating unit 93, configured to allocate one new label switching path identifier LSP ID to the ODUflex path after adjustment, and carry the new LSP ID in the request message sent to the downstream node;

and may further include:

a rollback triggering unit 94, configured to send a rollback indication message to the downstream node after a tributary slot adjustment failure indication or an ODUflex bit rate adjustment failure indication sent by the data plane is received.

As shown in FIG. 11, the node device further includes:

a saving unit 95, configured to create a control state for the path after adjustment, save control information, where the saved control information includes the tunnel ID, the bandwidth information after adjustment, and the new LSP ID, and save, to the corresponding control state, information of a tributary slot occupied by the ODUflex path after adjustment;

and may further include:

a first receiving unit 96, configured to receive a rollback indication message that is sent by the first node of the ODUflex path along the ODUflex path downstream node by node;

a judging unit 97, configured to: after the receiving unit receives the rollback indication message, judge whether the tributary slot adjustment of the data plane is successful; and

a rollback unit 98, configured to: in a case that the judging unit judges that the tributary slot adjustment is successful, execute a tributary slot adjustment rollback operation, and roll back to a state before the tributary slot adjustment.

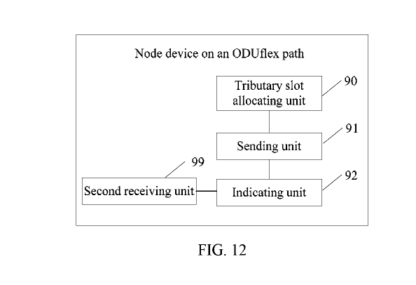

As shown in FIG. 12, the node device further includes:

a second receiving unit 99, configured to: in a case that the current node is not a first node, receive a request message sent by an upstream node of the current node, where the request message carries the tunnel identifier tunnel ID of the ODUflex path, the bandwidth information after adjustment and a label that contains tributary slot adjustment information determined by the upstream node, and the request message is used for requesting the lossless adjustment of the bandwidth of the ODUflex path; and

the indicating unit 92, further configured to send a second tributary slot adjustment command to the data plane according to the tributary slot adjustment information in the request message received by the second receiving unit, so that the data plane adjusts a tributary slot of a link connection between the upstream node and the current node according to the second tributary slot adjustment command.

The node device described in this embodiment corresponds to an upstream node of each link on an ODUflex path in Embodiment 2. To highlight an inventive point of the node device in this embodiment, some functions of the node device are ignored in this embodiment.

The node device described in the embodiment of the present invention can implement automatic ODUflex lossless bandwidth adjustment, and therefore, problems caused by manual bandwidth adjustment, such as a heavy work load and a configuration error, are avoided. Moreover, because an adjustment command does not need to be sent manually node by node during an ODUflex lossless bandwidth adjustment process, a bandwidth adjustment speed is increased, and a bandwidth adjustment requirement of a customer is satisfied rapidly.

Meanwhile, the node device in this embodiment provides a rollback mechanism, where a state before adjustment may be rolled back to in a case of adjustment failure, which effectively increases reliability of ODUflex lossless bandwidth adjustment.

### Embodiment 5

This embodiment provides a lossless bandwidth adjustment system, including a first node of an ODUflex path and a last node of the ODUflex path, and may further include an intermediate node.

The first node is configured to send a request message along the ODUflex path downstream node by node to the last node, where the request message carries a tunnel identifier tunnel ID of the ODUflex path and bandwidth information after adjustment, and the request message is used for requesting lossless adjustment of a bandwidth of the ODUflex path.

The last node is configured to receive the request message, search according to the tunnel identifier to obtain bandwidth information before adjustment of the ODUflex path, compare the bandwidth information before adjustment with the bandwidth information after adjustment, determine the number of tributary slots that need to be adjusted for a link between the last node and an adjacent upstream node, select a tributary slot that needs to be adjusted, indicate, through a first label, a tributary slot after adjustment of the upstream node or the selected tributary slot that needs to be adjusted, and send a tributary slot adjustment command to a data plane, so that the data plane performs tributary slot adjustment and ODUflex bit rate adjustment according to the tributary slot adjustment command, where the adjacent upstream node is the first node or an intermediate node between the first node and the last node.

The upstream node is configured to receive the first label, obtain the tributary slot that needs to be adjusted, and send a first tributary slot adjustment command to the data plane, so that, according to the first tributary slot adjustment command, the data plane adjusts a tributary slot of a link connection between the upstream node and the last node and performs ODUflex bit rate adjustment.

If the tributary slot adjustment command is a tributary slot increase command, the first node and the last node are further configured to perform the ODUflex bit rate adjustment after tributary slot adjustment of all link connections on the ODUflex path is completed.

If the tributary slot adjustment command is a tributary slot decrease command, a node on the ODUflex path is further configured to perform tributary slot adjustment of a link connection after the first node and the last node complete the ODUflex bit rate adjustment.

If the adjacent upstream node is the intermediate node between the first node and the last node, the upstream node is further configured to receive the request message, search according to the tunnel identifier to obtain the bandwidth information before adjustment of the ODUflex path, compare the bandwidth information before adjustment with the bandwidth information after adjustment, determine the number of tributary slots that need to be adjusted for a link between the upstream node and a previous node adjacent to the upstream node, select a tributary slot that needs to be adjusted, indicate, through a second label, a tributary slot after adjustment of the previous node adjacent to the upstream node or the selected tributary slot that needs to be adjusted, and send a second tributary slot adjustment command to the data plane, so that the data plane adjusts a tributary slot of a link connection between the upstream node and the previous node and performs the ODUflex bit rate adjustment according to the second tributary slot adjustment command.

The previous node adjacent to the upstream node is the first node or the intermediate node between the first node and the last node.

### Embodiment 6

This embodiment provides a lossless bandwidth adjustment system, including a first node of an ODUflex path and a downstream node of the ODUflex path, where the downstream node is a last node of the ODUflex path or an intermediate node between the first node and the last node.

The first node is configured to send a request message to an adjacent downstream node along the ODUflex path, where the request message carries a tunnel identifier tunnel ID of the ODUflex path, bandwidth information after adjustment and a label that contains tributary slot adjustment information determined by the first node, and the request message is used for requesting lossless adjustment of a bandwidth of the ODUflex path, and the tributary slot adjustment information includes a tributary slot after adjustment or a tributary slot that needs to be adjusted and is selected by the first node; the first node is further configured to allocate one new label switching path identifier LSP ID to the ODUflex path after bandwidth adjustment, and carry the new LSP ID in the request message sent to the downstream node. The first node is further configured to send a rollback indication message to the downstream node after a tributary slot adjustment failure indication or an ODUflex bit rate adjustment failure indication sent by the data plane is received.

The downstream node is configured to send a first tributary slot adjustment command to a data plane according to the tributary slot adjustment information, and in a case that the current node is not the last node of the ODUflex path, search according to the tunnel identifier to obtain bandwidth information before adjustment of the ODUflex path, compare the bandwidth information after adjustment with the bandwidth information before adjustment, determine the number of tributary slots that need to be adjusted for a link between the downstream node and a next node adjacent to this downstream node, determine tributary slot adjustment information according to the number of tributary slots that need to be adjusted, and continue to send, to the next node, a request message that carries the tunnel identifier tunnel ID of the ODUflex path, the bandwidth information after adjustment and a label that contains the tributary slot adjustment information determined by the downstream node.

The downstream node sends a second tributary slot adjustment command to the data plane. The data plane performs tributary slot adjustment and ODUflex bit rate adjustment according to the first tributary slot adjustment command and the second tributary slot adjustment command, where the data plane adjusts a tributary slot of a link connection between the first node and the downstream node according to the first tributary slot adjustment command, and adjusts a tributary slot of a link connection between the downstream node and the adjacent next node according to the second tributary slot adjustment command.

In conclusion, the ODUflex lossless bandwidth adjustment solution described in the embodiment implements automatic ODUflex lossless bandwidth adjustment without the need of manual participation, and therefore, problems caused by manual bandwidth adjustment, such as a heavy work load and a configuration error, are avoided. Moreover, because an adjustment command does not need to be sent manually node by node during an ODUflex lossless bandwidth adjustment process, a bandwidth adjustment speed is increased, and a bandwidth adjustment requirement of a customer is satisfied rapidly.

Meanwhile, the node device in this embodiment provides a rollback mechanism, where a state before adjustment may be rolled back to in a case of adjustment failure, which effectively increases reliability of ODUflex lossless bandwidth adjustment.

Persons of ordinary skill in the art may understand that, all or part of steps in the methods in the foregoing embodiments may be completed by a program instructing relevant hardware. The program may be stored in a computer readable storage medium, such as a read only memory (ROM for short), a random access memory (RAM for short), a magnetic disk and an optical disk.

The foregoing descriptions are merely specific exemplary embodiments of the present invention, but are not intended to limit the protection scope of the present invention. Any variation or replacement made by persons skilled in the art within the technical scope disclosed in the present invention shall fall within the protection scope of the present invention. Therefore, the protection scope of the present invention shall be subject to the appended claims.

1. A lossless bandwidth adjustment method, comprising:
receiving, by a downstream node of a bandwidth-variable optical channel data unit (ODU)flex path, a request message from an upstream node of the ODUflex path, wherein the request message carries a tunnel identifier (tunnel ID) of the ODUflex path and second bandwidth information after adjustment, the request message is used for requesting lossless adjustment of a bandwidth of the ODUflex path, and the request message is sent by a first node of the ODUflex path along the ODUflex path, downstream node by node to a last node;
searching, by the downstream node, according to the tunnel identifier to obtain first bandwidth information before the adjustment of the ODUflex path, comparing the first bandwidth information before the adjustment with the second bandwidth information after the adjustment, determining quantity of tributary slots that need to be adjusted for a link between the downstream node and an adjacent upstream node, and selecting a tributary slot that needs to be adjusted; and
indicating, by the downstream node and through a label, a tributary slot after the adjustment of the adjacent upstream node or the selected tributary slot that needs to be adjusted, and sending a tributary slot adjustment command to a data plane, so that the data plane performs tributary slot adjustment and ODUflex bit rate adjustment according to the tributary slot adjustment command.

2. The method according to claim 1, further comprising:
allocating, by the first node of the ODUflex path, one new label switching path identifier (LSP ID) to the ODUflex path after the adjustment, and carrying the new LSP ID in the request message.

3. The method according to claim 1, wherein the indicating, by the downstream node and through the label, the tributary slot after the adjustment of the adjacent upstream node or the selected tributary slot that needs to be adjusted comprises one of the group consisting of:
sending, to the upstream node, a response message, which carries an old label and a new label, wherein the new label contains a tributary slot that is occupied by the ODUflex path after the adjustment in a link between the upstream node and the downstream node, and the old label contains a tributary slot that is occupied by the ODUflex path before the adjustment in the link between the upstream node and the downstream node;
sending, to the upstream node, the response message, which carries the new label, wherein the new label contains the tributary slot that is occupied by the ODUflex path after the adjustment in the link between the upstream node and the downstream node;
sending the response message upstream, which carries the new label, wherein the new label contains the selected tributary slot that needs to be adjusted, and indicates whether the tributary slot adjustment is an increase of the quantity of the tributary slots or a decrease of the quantity of the tributary slots.

4. The method according to claim 3, wherein
if the response message, which carries the old label and the new label, is sent to the upstream node, wherein the new label contains the tributary slot that is occupied by the ODUflex path after the adjustment in the link between the upstream node and the downstream node, and the old label contains the tributary slot that is occupied by the ODUflex path before the adjustment in the link between the upstream node and the downstream node, the method further comprises:
comparing, by the upstream node, the new label with the old label to know the tributary slot that needs to be adjusted; or
if the downstream node sends, to the upstream node, the response message, which carries the new label, wherein the new label contains the tributary slot that is occupied by the ODUflex path after the adjustment in the link between the upstream node and the downstream node, the method further comprises:
searching by the upstream node according to the tunnel identifier in the request message to obtain the old label of the ODUflex path, wherein the old label contains the tributary slot that is occupied by the ODUflex path before the adjustment in the link between the upstream node and the downstream node; and comparing the new label with the old label to know the tributary slot that needs to be adjusted.

5. The method according to claim 1, wherein the sending the tributary slot adjustment command to the data plane, so that the data plane performs the tributary slot adjustment and the ODUflex bit rate adjustment according to the tributary slot adjustment command comprises:
if the tributary slot adjustment command is a tributary slot increase command, performing, by the data plane, the ODUflex bit rate adjustment after tributary slot adjustment of all link connections on the ODUflex path is completed; and
if the tributary slot adjustment command is a tributary slot decrease command, performing, by the data plane, tributary slot adjustment of a link connection on the ODUflex path after completing the ODUflex bit rate adjustment.

6. The method according to claim 1, wherein if a tributary slot adjustment failure indication or an ODUflex bit rate adjustment failure indication sent by the data plane is received, the method further comprises:
sending, by the first node of the ODUflex path, a rollback indication message along the ODUflex path downstream node by node; and
after receiving the rollback indication message, judging, by each node on the ODUflex path, whether the tributary slot adjustment of the data plane is successful previously, and if successful, executing a tributary slot adjustment rollback operation, and rolling back to a state before the tributary slot adjustment.

7. A lossless bandwidth adjustment method, comprising:
sending, by an upstream node of a bandwidth-variable optical channel data unit (ODU)flex path, a request message to a downstream node, wherein the request message carries a tunnel identifier (tunnel ID) of the ODUflex path, second bandwidth information after adjustment and a first label that contains tributary slot adjustment information determined by the upstream node, the request message is used for requesting lossless adjustment of a bandwidth of the ODUflex path, and the tributary slot adjustment information comprises a first tributary slot after the adjustment or a second tributary slot that needs to be adjusted and is selected by the upstream node;
sending, by the downstream node, a first tributary slot adjustment command to a data plane according to the tributary slot adjustment information, and when a current node is not a last node of the ODUflex path, searching according to the tunnel identifier to obtain first bandwidth information before the adjustment of the ODUflex path, comparing the second bandwidth information after the adjustment with the first bandwidth information before the adjustment, determine the quantity of tributary slots that need to be adjusted for a link between the downstream node and a next node adjacent to the downstream node, determining tributary slot adjustment information according to the quantity of the tributary slots that need to be adjusted, and continuing to send, to the next node, the request message that carries the tunnel ID of the ODUflex path, the second bandwidth information after the adjustment and a second label that contains the tributary slot adjustment information determined by the downstream node;
sending, by the downstream node, a second tributary slot adjustment command to the data plane; and
performing, by the data plane, tributary slot adjustment and ODUflex bit rate adjustment according to the first tributary slot adjustment command and the second tributary slot adjustment command, wherein the data plane adjusts a tributary slot of a link connection between the upstream node and the downstream node according to the first tributary slot adjustment command, and adjusts a tributary slot of a link connection between the downstream node and the adjacent next node according to the second tributary slot adjustment command.

8. The method according to claim 7, wherein the performing, by the data plane, the tributary slot adjustment and ODUflex bit rate adjustment according to the first tributary slot adjustment command and the second tributary slot adjustment command comprises:
if the first tributary slot adjustment command and the second tributary slot adjustment command are tributary slot increase commands, performing, by the data plane, the ODUflex bit rate adjustment after tributary slot adjustment of all link connections on the ODUflex path is completed; and
if the first tributary slot adjustment command and the second tributary slot adjustment command are tributary slot decrease commands, performing, by the data plane, the tributary slot adjustment of a link connection on the ODUflex path after completing the ODUflex bit rate adjustment.

9. A node device on an optical channel data unit (ODU)flex path, comprising:
a receiving unit, configured to receive a request message from an upstream node of the ODUflex path, wherein the request message carries a tunnel identifier (tunnel ID) of the ODUflex path and second bandwidth information after adjustment, and the request message is used for requesting lossless adjustment of a bandwidth of the ODUflex path;
a tributary slot allocating unit, configured to search according to the tunnel identifier to obtain first bandwidth information before the adjustment of the ODUflex path, compare the first bandwidth information before the adjustment with the second bandwidth information after the adjustment, determine quantity of tributary slots that need to be adjusted for a link between the node device and an adjacent upstream node, and select a tributary slot that needs to be adjusted; and
an indicating unit, configured to indicate, through a label, a tributary slot after the adjustment of the adjacent upstream node or the selected tributary slot that needs to be adjusted, and send a tributary slot adjustment command to a data plane, so that the data plane performs tributary slot adjustment and ODUflex bit rate adjustment according to the tributary slot adjustment command.

10. The node device according to claim 9, wherein the request message received by the receiving unit contains a new label switching path identifier (LSP ID) allocated by a first node of the ODUflex path to the ODUflex path after the adjustment.

11. The node device according to claim 9, wherein the receiving unit is further configured to receive a rollback indication message that is sent by the first node of the ODUflex path along the ODUflex path downstream node by node, and the node device further comprises:
a judging unit, configured to: after the receiving unit receives the rollback indication message, judge whether the tributary slot adjustment of the data plane is successful; and
a rollback unit, configured to: when the judging unit judges that the tributary slot adjustment is successful, execute a tributary slot adjustment rollback operation, and roll back to a state before the tributary slot adjustment.

12. A node device on an optical channel data unit (ODU)flex path, comprising:
a tributary slot allocating unit, configured to: that a current node is not a last node of the ODUflex path, compare second bandwidth information after adjustment of the ODUflex path with first bandwidth information before the adjustment, determine a quantity of tributary slots that need to be adjusted for a link between the current node and an adjacent next node, and determine tributary slot adjustment information according to the quantity of the tributary slots that need to be adjusted, wherein the tributary slot adjustment information comprises: a tributary slot after the adjustment or a selected tributary slot that needs to be adjusted;
a sending unit, configured to send a request message to a downstream node, wherein the request message carries a tunnel identifier (tunnel ID) of the ODUflex path, the second bandwidth information after the adjustment and a label that contains the tributary slot adjustment information determined by the current node, the request message is used for requesting lossless adjustment of a bandwidth of the ODUflex path; and
an indicating unit, configured to send a first tributary slot adjustment command to a data plane according to the tributary slot adjustment information, so that the data plane adjusts a tributary slot of a link connection between the current node and the adjacent next node according to the first tributary slot adjustment command.

13. The node device according to claim 12, further comprising a path identifier allocating unit wherein when the node device is a first node of the ODUflex path,
the path identifier allocating unit is configured to allocate one new label switching path identifier (LSP ID) to the ODUflex path after the adjustment, and carry the new LSP ID in the request message sent to the downstream node.

14. The node device according to claim 13, further comprising:
a rollback triggering unit, configured to send a rollback indication message to the downstream node after a tributary slot adjustment failure indication or an ODUflex bit rate adjustment failure indication sent by the data plane is received.

15. The node device according to claim 12, further comprising:
a first receiving unit, configured to receive a rollback indication message that is sent by a first node of the ODUflex path along the ODUflex path downstream node by node;
a judging unit, configured to: after the receiving unit receives the rollback indication message, judge whether the tributary slot adjustment of the data plane is successful; and
a rollback unit, configured to: when the judging unit judges that the tributary slot adjustment is successful, execute a tributary slot adjustment rollback operation, and roll back to a state before the tributary slot adjustment.

16. The node device according to claim 12, further comprising:
a second receiving unit, configured to: when the current node is not a first node, receive a request message sent by an upstream node of the current node, wherein the request message carries the tunnel ID of the ODUflex path, the second bandwidth information after the adjustment and a label that contains tributary slot adjustment information determined by the upstream node, and the request message is used for requesting the lossless adjustment of the bandwidth of the ODUflex path; and
the indicating unit, further configured to send a second tributary slot adjustment command to the data plane according to the tributary slot adjustment information in the request message received by the second receiving unit, so that the data plane adjusts a tributary slot of a link connection between the upstream node and the current node according to the second tributary slot adjustment command.

17. A lossless bandwidth adjustment system, comprising a first node of an optical channel data unit (ODU)flex path and a last node of the ODUflex path, wherein:
the first node is configured to send a request message along the ODUflex path downstream node by node to the last node, wherein the request message carries a tunnel identifier (tunnel ID) of the ODUflex path and second bandwidth information after adjustment, and the request message is used for requesting lossless adjustment of a bandwidth of the ODUflex path;
the last node is configured to receive the request message, search according to the tunnel identifier to obtain first bandwidth information before the adjustment of the ODUflex path, compare the first bandwidth information before the adjustment with the second bandwidth information after the adjustment, determine quantity of tributary slots that need to be adjusted for a link between the last node and an adjacent upstream node, select a tributary slot that needs to be adjusted, indicate, through a first label, a tributary slot after the adjustment of the upstream node or the selected tributary slot that needs to be adjusted, and send a tributary slot adjustment command to a data plane, so that the data plane performs tributary slot adjustment and ODUflex bit rate adjustment according to the tributary slot adjustment command, wherein the adjacent upstream node is the first node or an intermediate node between the first node and the last node; and
the upstream node is configured to receive the first label, obtain the tributary slot that needs to be adjusted, and send a first tributary slot adjustment command to the data plane, so that, according to the first tributary slot adjustment command, the data plane adjusts a tributary slot of a link connection between the upstream node and the last node and performs the ODUflex bit rate adjustment.

18. The system according to claim 17, wherein,
if the tributary slot adjustment command is a tributary slot increase command, the first node and the last node are further configured to perform the ODUflex bit rate adjustment after tributary slot adjustment of all link connections on the ODUflex path is completed;
if the tributary slot adjustment command is a tributary slot decrease command, a node on the ODUflex path is further configured to perform tributary slot adjustment of a link connection after the first node and the last node complete the ODUflex bit rate adjustment.

19. The system according to claim 17, wherein if the adjacent upstream node is the intermediate node between the first node and the last node, the upstream node is further configured to receive the request message, search according to the tunnel identifier to obtain the first bandwidth information before the adjustment of the ODUflex path, compare the first bandwidth information before the adjustment with the second bandwidth information after the adjustment, determine the quantity of the tributary slots that need to be adjusted for a link between the upstream node and a previous node adjacent to the upstream node, select a tributary slot that needs to be adjusted, indicate, through a second label, a tributary slot after the adjustment of the previous node adjacent to the upstream node or the selected tributary slot that needs to be adjusted, and send a second tributary slot adjustment command to the data plane, so that the data plane adjusts a tributary slot of a link connection between the upstream node and the previous node and performs the ODUflex bit rate adjustment according to the second tributary slot adjustment command; and
the previous node adjacent to the upstream node is the first node or the intermediate node between the first node and the last node.

20. A lossless bandwidth adjustment system, comprising a first node of an optical channel data unit (ODU)flex path and a downstream node of the ODUflex path, wherein the downstream node is a last node of the ODUflex path or an intermediate node between the first node and the last node;
the first node is configured to send a request message to an adjacent downstream node along the ODUflex path, wherein the request message carries a tunnel identifier (tunnel ID) of the ODUflex path, second bandwidth information after adjustment and a label that contains tributary slot adjustment information determined by the first node, the request message is used for requesting lossless adjustment of a bandwidth of the ODUflex path, and the tributary slot adjustment information comprises a tributary slot after the adjustment or a tributary slot that needs to be adjusted and is selected by the first node;
the downstream node is configured to send a first tributary slot adjustment command to a data plane according to the tributary slot adjustment information, and when the current node is not the last node of the ODUflex path, search according to the tunnel identifier to obtain first bandwidth information before the adjustment of the ODUflex path, compare the second bandwidth information after the adjustment with the first bandwidth information before the adjustment, determine the quantity of tributary slots that need to be adjusted for a link between the downstream node and a next node adjacent to the downstream node, determine the tributary slot adjustment information according to the quantity of the tributary slots that need to be adjusted, and continue to send, to the next node, a request message that carries the tunnel ID of the ODUflex path, the second bandwidth information after the adjustment and a label that contains the tributary slot adjustment information determined by the downstream node; and
the downstream node sends a second tributary slot adjustment command to the data plane; and the data plane performs tributary slot adjustment and ODUflex bit rate adjustment according to the first tributary slot adjustment command and the second tributary slot adjustment command, wherein the data plane adjusts a tributary slot of a link connection between the first node and the downstream node according to the first tributary slot adjustment command, and adjusts a tributary slot of a link connection between the downstream node and the adjacent next node according to the second tributary slot adjustment command.

21. The system according to claim 20, wherein the first node is further configured to allocate one new label switching path identifier (LSP ID) to the ODUflex path after bandwidth adjustment, and carry the new LSP ID in the request message sent to the downstream node.

22. The system according to claim 20, wherein the first node is further configured to send a rollback indication message to the downstream node after a tributary slot adjustment failure indication or an ODUflex bit rate adjustment failure indication sent by the data plane is received.
